(19) United States
(12) Patent Application Publication
(10) Pub. No.: US 2024/0048500 A1
(43) Pub. Date: Feb. 8, 2024

(54) IP TELEPHONE SYSTEM, TRAFFIC CONTROL METHOD, TRAFFIC CONTROL PROGRAM, AND TRAFFIC CONTROL DEVICE

(71) Applicant: NIPPON TELEGRAPH AND TELEPHONE CORPORATION, Tokyo (JP)

(72) Inventors: Fumiaki NAGASE, Musashino-shi, Tokyo (JP); Masafumi YOSHIOKA, Musashino-shi, Tokyo (JP); Toshifumi MIYAGI, Musashino-shi, Tokyo (JP)

(73) Assignee: NIPPON TELEGRAPH AND TELEPHONE CORPORATION, Tokyo (JP)

(21) Appl. No.: 18/268,693

(22) PCT Filed: Dec. 23, 2020
(86) PCT No.: PCT/JP2020/048290

§ 371 Date: Jun. 21, 2023

(51) Int. Cl. H04L 47/32; H04M 7/00; H04L 43/0882; H04L 47/2416

(52) U.S. Cl. CPC H04L 47/32; H04M 7/0084; H04L 43/0882; H04L 47/2416

(57) ABSTRACT

An Internet Protocol (IP) phone system includes a traffic control device connected to a line. The traffic control device acquires a call duration of each of calls on one line shared by a plurality of IP phones, and sets a packet discard rate of each of the calls in a manner where the packet discard rate is proportional to the call duration until start of a new call so that total call traffic falls within a line capacity of the one line when the total call traffic exceeds the line capacity with the start of the new call.

### TECHNICAL FIELD

The present invention relates to technology for controlling traffic in an Internet Protocol (IP) phone system.

### BACKGROUND ART

At the time of disaster, communication traffic greatly increases, and user communication is difficult to be secured. Furthermore, important communication of police, fire departments, and the like are also affected. Therefore, communication carriers take measures against congestion of communication traffic as necessary. For example, in order to reduce the communication traffic, to secure minimum call duration for safety confirmation and the like is efficient. Therefore, there is a method for restricting call duration by forcibly disconnecting calls that are communication established between specific individuals in general phones (see Non Patent Literature 1). Furthermore, in MCA radio, operation of restricting a one-time call duration is implemented (see Non Patent Literature 2).

On the other hand, “IP phones” using data communication (packet communication) have also been widespread. Unlike a line switching type general phone that occupies a line during a call, in an IP phone, a line is occupied only when packets are transmitted and received. Therefore, in an IP phone, calls of a plurality of IP phones can share one line. Forcible disconnection and restriction of a call duration are not performed even in a call congestion state. Instead, packets that exceed a line capacity of one line shared by a plurality of IP phones are discarded. Although voice quality is deteriorated due to the packet discard, IP phones tend to be easily connected even in a congestion state. Therefore, IP phones are regarded as promising communication means in the event of disaster or emergency.

### CITATION LIST

### Non Patent Literature

Non Patent Literature 1: K. Tanabe, S. Miyata, K. Baba and K. Yamaoka, “Threshold Relaxation and Holding Time Limitation Method for Accepting More General Calls under Emergency Trunk Reservation”, IEICE Transaction on Fundamentals of Electronics, Communications and Computer Sciences, pp. 1518-1528, August 2016.
Non Patent Literature 2: K. Suzuki, T. Yoshida, and Y. Mizutani, “Operation Analysis and Application to Design of Traffic of MCA Radio System”, IEICE Transactions, B-II Vol., J80-B-II No. 1, pp. 44-53, January 1997

### SUMMARY OF INVENTION

### Technical Problem

At the time of congestion of an IP phone line, packets that exceed the line capacity of one line shared by a plurality of IP phones are discarded. According to conventional IP phones, packets of all calls using the line are uniformly (evenly) discarded. Therefore, communication quality (voice quality) of all the calls is uniformly deteriorated. This leads to a decrease in satisfaction levels of all users.

One object of the present invention is to provide technology capable of suppressing uniform deterioration of communication quality of all calls sharing one certain line at the time of congestion of the IP phone line.

### Solution to Problem

A first aspect relates to an IP phone system.

An IP phone system includes a traffic control device connected to a line.

The traffic control device executes:
processing of acquiring a call duration of each of calls on one line shared by a plurality of IP phones; and
first setting processing of setting a packet discard rate of each of the calls in a manner where the packet discard rate is proportional to the call duration until start of a new call so that total call traffic falls within a line capacity of the one line when the total call traffic exceeds the line capacity with the start of the new call.

A second aspect relates to a traffic control method in an IP phone system.

A traffic control method includes:
processing of acquiring a call duration of each of calls on one line shared by a plurality of IP phones; and
first setting processing of setting a packet discard rate of each of the calls in a manner where the packet discard rate is proportional to the call duration until start of a new call so that total call traffic falls within a line capacity of the one line when the total call traffic exceeds the line capacity with the start of the new call.

A third aspect relates to a traffic control program. A traffic control program is executed by a computer and causes the computer to execute the above traffic control method. The traffic control program may be recorded on a computer-readable recording medium. The traffic control program may be provided via a network.

A fourth aspect relates to a traffic control device in an IP phone system.

A traffic control device includes an information processing device.

The information processing device executes:
processing of acquiring a call duration of each of calls on one line shared by a plurality of IP phones; and
first setting processing of setting a packet discard rate of each of the calls in a manner where the packet discard rate is proportional to the call duration until start of a new call so that total call traffic falls within a line capacity of the one line when the total call traffic exceeds the line capacity with the start of the new call.

### Advantageous Effects of Invention

According to the present invention, when total call traffic exceeds a line capacity with start of a new call, a packet discard rate of each of the calls is set in a manner where the packet discard rate is proportional to a call duration. As a result, for a call having a short call duration, deterioration of communication quality is suppressed. That is, uniform deterioration in communication quality of all calls can be suppressed.

### BRIEF DESCRIPTION OF DRAWINGS

FIG. 1 is a schematic diagram illustrating a configuration example of an IP phone system according to an embodiment of the present invention.

FIG. 2 is a block diagram illustrating one example of disposition of traffic control devices according to the embodiment of the present invention.

FIG. 3 is a block diagram illustrating another example of disposition of the traffic control devices according to the embodiment of the present invention.

FIG. 4 is a conceptual diagram for describing a first example of packet discard control processing according to the embodiment of the present invention.

FIG. 5 is a flowchart illustrating the first example of the packet discard control processing according to the embodiment of the present invention.

FIG. 6 is a conceptual diagram for describing a second example of the packet discard control processing according to the embodiment of the present invention.

FIG. 7 is a conceptual diagram for describing the second example of the packet discard control processing according to the embodiment of the present invention.

FIG. 8 is a conceptual diagram for describing the second example of the packet discard control processing according to the embodiment of the present invention.

FIG. 9 is a flowchart illustrating the second example of the packet discard control processing according to the embodiment of the present invention.

FIG. 10 is a block diagram illustrating a configuration example of each of the traffic control devices according to the embodiment of the present invention.

FIG. 11 is a block diagram illustrating a functional configuration example of the traffic control device on a side of a base station according to the embodiment of the present invention.

FIG. 12 is a conceptual diagram illustrating one example of a call management table according to the embodiment of the present invention.

FIG. 13 is a block diagram illustrating a functional configuration example of the traffic control device on a side of a terminal station according to the embodiment of the present invention.

### DESCRIPTION OF EMBODIMENTS

Embodiments of the present invention will be described with reference to the accompanying drawings.

### 1. IP Phone System

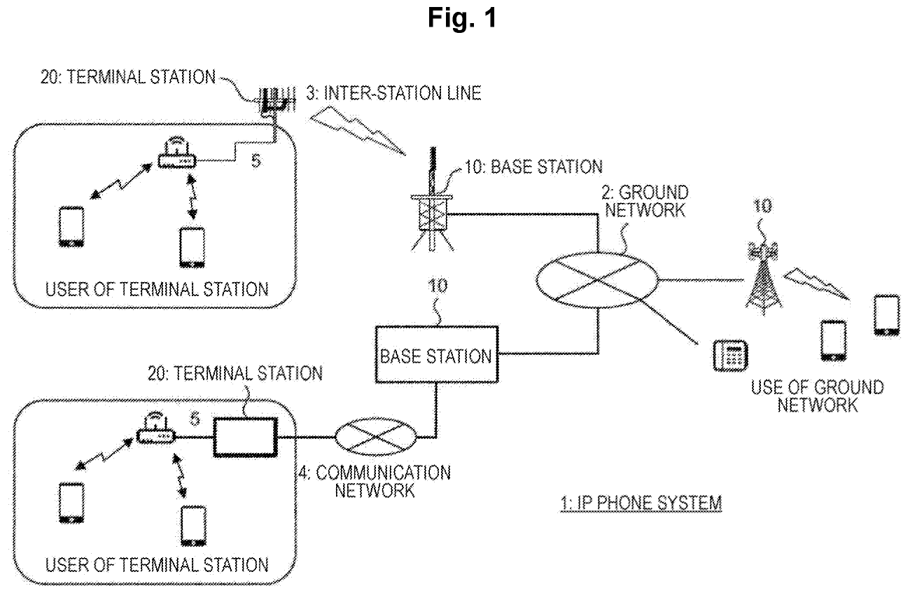

FIG. 1 is a schematic diagram illustrating a configuration example of an IP phone system 1 according to the present embodiment. The IP phone system 1 includes base stations 10 and terminal stations 20. The base stations 10 are connected to a ground network 2. The terminal stations 20 are installed, for example, in organizations related to disaster prevention, organizations related to living, shelters, or the like in a community. Each of the base stations 10 and the relevant terminal station 20 are connected to each other via a wireless inter-station line 3 or a wired communication network 4. Each of the base stations 10 and the relevant terminal station 20 communicate with each other via the inter-station line 3 or the communication network 4. Each of the terminal stations 20 is connected to a terminal station network 5. In the above-described IP phone system 1, for example, a user of the ground network 2 and a user of the terminal station 20 make a call by an IP phone. One line of the inter-station line 3 or the communication network 4 is shared by a plurality of IP phones (calls).

In the IP phones, since a real-time property is required, UDP/IP (User Datagram Protocol/Internet Protocol) is used. Unlike TCP (Transmission Control Protocol), retransmission control is not performed in UDP/IP. Therefore, in a case where call traffic equal to or higher than a line capacity of an IP phone line is generated, packets that exceed the line capacity are discarded. For example, in the IP phone system 1 illustrated in FIG. 1, in a case where call traffic equal to or higher than the line capacity of one line of the inter-station line 3 or the communication network 4 between the base station 10 and the terminal station 20 is generated, packets that exceed the line capacity are discarded.

The IP phone system 1 according to the present embodiment dynamically controls a packet discard rate of each call on one line. For this purpose, the IP phone system 1 includes traffic control devices 100. The traffic control devices 100 are disposed in association with the stations that control a communication volume of the IP phones (e.g., base stations 10 and terminal stations 20).

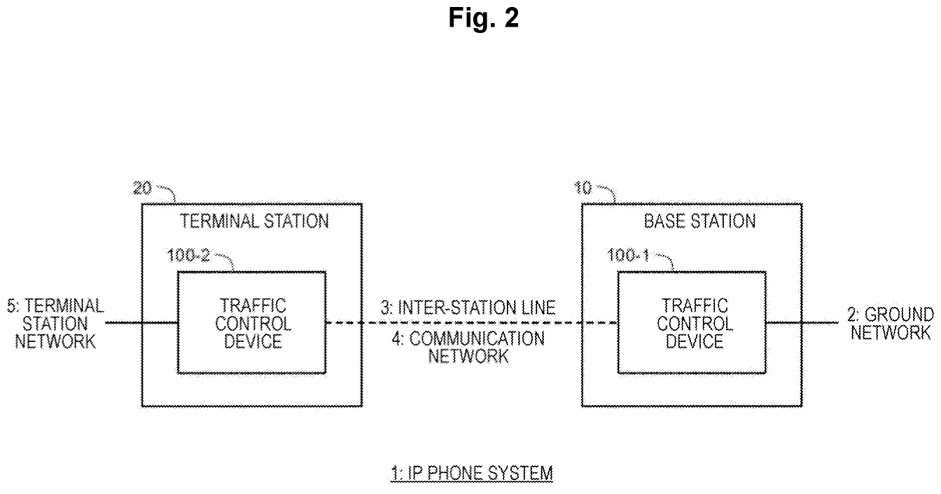

FIG. 2 is a block diagram illustrating one example of disposition of the traffic control devices 100. In the example illustrated in FIG. 2, a traffic control device 100-1 is disposed inside the base station 10, and a traffic control device 100-2 is disposed inside the terminal station 20. Each of the traffic control devices 100-1 and 100-2 controls the packet discard rate on the IP phone line (inter-station line 3 or communication network 4) between the base station 10 and the terminal station 20.

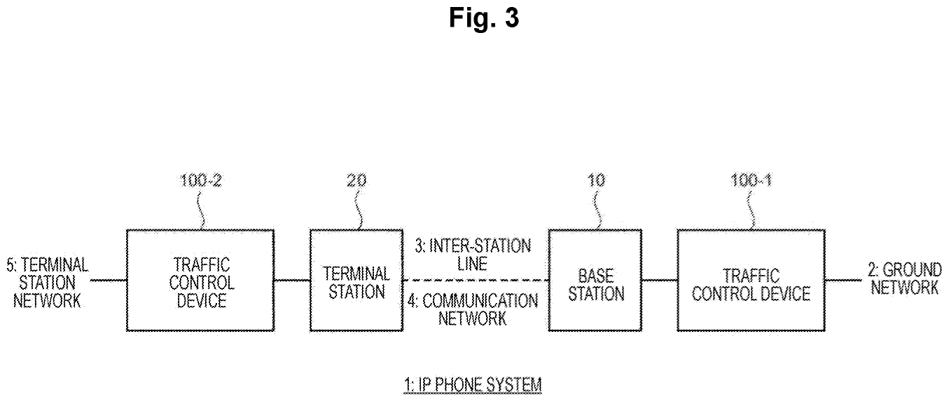

FIG. 3 is a block diagram illustrating another example of disposition of the traffic control devices 100. In the example illustrated in FIG. 3, the traffic control device 100-1 is disposed between the base station 10 and the ground network 2, and the traffic control device 100-2 is disposed between the terminal station 20 and the “user of the terminal station 20”. In this case, each of the traffic control devices 100-1 and 100-2 can also control the packet discard rate on the IP phone line (inter-station line 3 or communication network 4) between the base station and the terminal station 20.

The traffic control devices 100 according to the present embodiment each discard the packets while appropriately controlling the packet discard rate at the time of congestion. This processing will be referred to as “packet discard control processing” hereinafter. Hereinafter, the “packet discard control processing” by each of the traffic control devices 100 will be described.

### 2. Outline of Packet Discard Control Processing

A number of simultaneous calls z is a number of calls simultaneously using a certain line. For example, the number of simultaneous calls z is a number of calls that are simultaneously establishing sessions at certain time on one line of the inter-station line 3 or the communication network 4. The line capacity of the one line is denoted by B_{L}. In addition, a traffic amount of one call is set to B_{V}. Total call traffic is represented by z×B_{V}.

When the total call traffic is equal to or lower than the line capacity B_{L}, that is, when a relationship represented by a following expression (1) is established, the packet discard control processing is not performed. On the other hand, when the total call traffic exceeds the line capacity B_{L}, that is, when a relationship represented by a following expression (2) is established, the packet discard control processing is performed.

$$\begin{matrix}[ Math . 1 ] & \\ z \leq \frac{{B}_{L}}{{B}_{V}} & ( 1 )\end{matrix}$$

$$\begin{matrix}[ Math . 2 ] & \\ z > \frac{{B}_{L}}{{B}_{V}} & ( 2 )\end{matrix}$$

When the relationship represented by the expression (2) is established, a short traffic amount E_{d} is represented by a following expression (3).

[Math. 3]

E_{d}=zB_{V}−B_{L} (3)

The traffic control device 100 performs the packet discard control processing so that the total call traffic falls within the line capacity B_{L}. At this time, the packets are discarded by the short traffic amount E_{d} represented by the above expression (3). In this sense, the short traffic amount E_{d} can be referred to as a “total discard traffic amount E_{d}”. In order to achieve the total discard traffic amount E_{d}, the traffic control device 100 appropriately sets a packet discard rate Dₙ of each call. Here, n takes a value of 1 to z.

First, as a comparative example, a case where the packet discard rates Dₙ of all the calls are uniformly (evenly) set will be considered. This means that the total discard traffic amount E_{d} is equally allocated to all the calls. In this comparative example, communication quality (voice quality) of all the calls is uniformly deteriorated. This leads to a decrease in satisfaction levels of all users, and it cannot be said that the optimal traffic control is performed.

On the other hand, according to the present embodiment, the total discard traffic amount E_{d} is allocated in accordance with a call duration tₙ of each of the calls. That is, the traffic control device 100 sets the packet discard rate Dₙ of each of the calls on the basis of the call duration tₙ of each of the calls. More specifically, the longer the call duration tₙ is, the higher the packet discard rate Dₙ is set. Conversely, the shorter the call duration tₙ is, the lower the packet discard rate Dₙ is set.

In a case where the call duration tₙ is long, necessary information has highly likely already been transmitted, so that decrease in voice quality is not necessarily an issue. Rather, at the time of congestion, it is preferable that a line resource is transferred to a user having a short call duration tₙ or a new user. For example, at the time of disaster, it is considered that many users want to perform at least safety confirmation. According to the present embodiment, for a call with the short call duration tₙ, the packet discard rate Dₙ is set low, and thus decrease in voice quality is suppressed. Therefore, it is possible to satisfactorily transmit important information such as safety confirmation.

On the other hand, for a call with the long call duration tₙ, the packet discard rate Dₙ is set high, and thus the voice quality is decreased. When the voice quality decreases, a user is expected to feel like ending the call. That is, as the call duration tₙ is longer, a possibility that the user ends the call is higher. Ending the call having the long call duration tₙ releases the line resource, and improves call quality of a call of another user. Furthermore, a call of a new user is easier to be accepted, and a call loss probability is decreased.

As described above, in the present embodiment, the voice quality of all the calls is not uniformly degraded. As a result, the satisfaction levels of the users are improved as a whole.

### 3. Specific Example of Packet Discard Control Processing

Hereinafter, several specific examples of the packet discard control processing according to the present embodiment will be described.

### 3-1. First Example

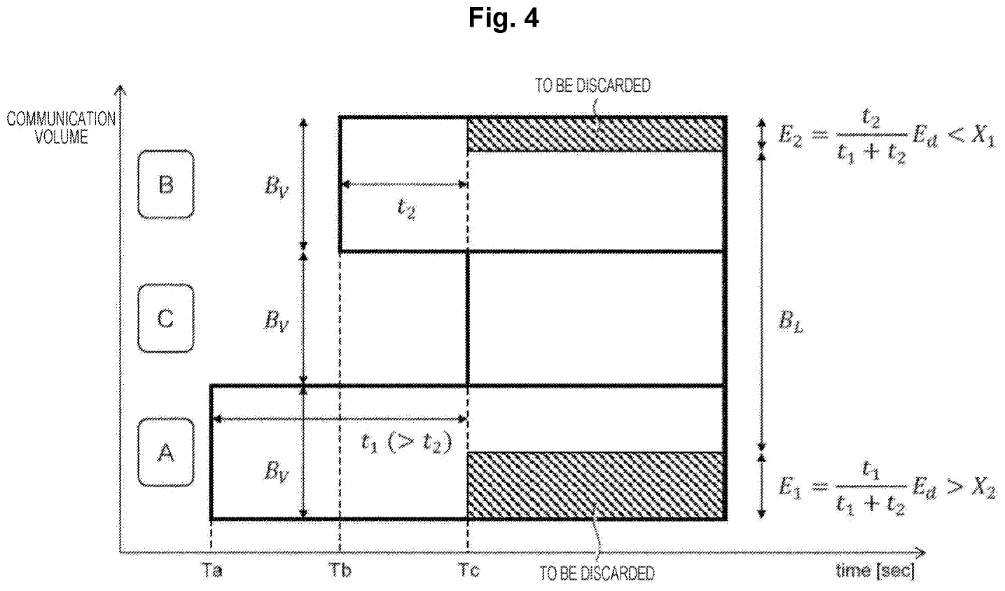

FIG. 4 is a conceptual diagram for describing a first example of the packet discard control processing according to the present embodiment. At time ta, a user A (terminal A) starts a call. At time Tb after the time Ta, another user B (terminal B) starts a call. At time Tc after the time Tb, still another user C (terminal C) starts a call. With the start of the new call by this user C, the total call traffic exceeds the line capacity B_{L}. In response to the start of the new call, the traffic control device 100 performs the packet discard control processing.

In the packet discard control processing, the traffic control device 100 sets the packet discard rate Dₙ of each of the calls so that the total call traffic falls within the line capacity B_{L}. This is equivalent to allocating the total discarded traffic amount E_{d} (see the expression (3)) to each of the calls so that the total call traffic falls within the line capacity B_{L}. According to the first example, the total discard traffic amount E_{d} is proportionally allocated in accordance with the call duration tₙ until the start of the new call. That is, the packet discard rate Dₙ of each of the calls is set so as to be proportional to the call duration tₙ until the start of the new call. The above-described packet discard rate Dₙ is represented by a following expression (4).

$$\begin{matrix}[ Math . 4 ] & \\ {D}_{n} = \frac{{t}_{n}}{{\sum }_{k = 1}^{z} {t}_{k}} ( \frac{{E}_{d}}{{B}_{V}} ) & ( 4 )\end{matrix}$$

For example, in the example shown in FIG. 4, the call duration of the user A until the start of the new call is t₁, and the call duration of the user B is t₂. The call duration t₁ of the user A is longer than the call duration t₂ of the user B. The total discard traffic amount E_{d} is proportionally allocated in accordance with the call durations t₁, t₂. Of the total discard traffic amount E_{d}, a discard traffic amount E₁ according to the call duration t₁ is allocated to the call of the user A, and a discard traffic amount E₂ according to the call duration t₂ is allocated to the call of the user B. The discard traffic amount E₁ (packet discard rate D₁) for the call of the user A is larger than the discard traffic amount E₂ (packet discard rate D₂) for the call of the user B. Note that a packet discard rate D₃ of the new call by the user C is zero.

As described above, the longer the call duration tₙ is, the higher the packet discard rate Dₙ is, and the shorter the call duration tₙ is, the lower the packet discard rate Dₙ is set. Therefore, the above-described excellent effects can be obtained. In particular, as a result of the proportional allocation according to the call duration tₙ, the packet discard rate Dₙ of a new call is set to zero. Therefore, particularly good call quality is secured for a new call. In other words, it is possible to prevent a situation in which only low call quality can be obtained despite a new call. This is preferable from the viewpoint of the satisfaction level of the user.

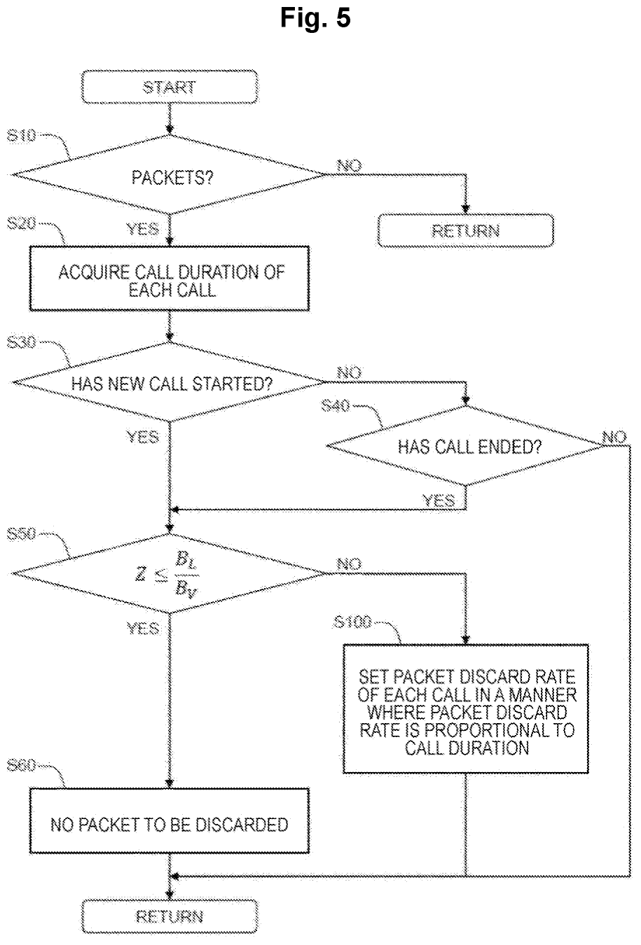

FIG. 5 is a flowchart illustrating the first example of the packet discard control processing.

In step S10, the traffic control device 100 determines whether the packet has arrived. If the packet arrives (step S10; Yes), the processing proceeds to step S20.

In step S20, the traffic control device 100 acquires information of the number of simultaneous calls z and the call duration tₙ of each call.

In step S30, the traffic control device 100 determines whether or not a new call has been started. If a new call has been started (step S30; Yes), the processing proceeds to step S50. Otherwise (step S30; No), the processing proceeds to step S40.

In step S40, the traffic control device 100 determines whether or not a certain call has ended. If a certain call has ended (step S40; Yes), the processing proceeds to step S50. Otherwise (step S50; No), the processing in this cycle ends.

In step S50, the traffic control device 100 determines whether or not the total call traffic is equal to or lower than the line capacity B_{L}, that is, whether or not the relationship represented by the above expression (1) is established. If the total call traffic is equal to or lower than the line capacity B_{L} (step S50; Yes), the processing proceeds to step S60. On the other hand, If the total call traffic exceeds the line capacity B_{L} (step S50; No), the processing proceeds to step S100.

In step S60, the traffic control device 100 does not perform the packet discard control processing.

In step S100, the traffic control device 100 sets the packet discard rate Dₙ of each of the calls so that the total call traffic falls within the line capacity B_{L}. In particular, the traffic control device 100 sets the packet discard rate Dₙ of each of the calls in a manner where the packet discard rate Dₙ is proportional to the call duration to of each of the calls. The above processing of setting the packet discard rate Dₙ is hereinafter referred to as “first setting processing” for convenience.

The above-described excellent effects can be obtained by the first setting processing. In particular, good call quality is secured for a new call. In other words, it is possible to prevent the situation in which only low call quality can be obtained despite a new call.

### 3-2. Second Example

A second example will be described as a modification of the first example. In the second example, a “packet discard rate upper limit P_{R}” that is a predetermined upper limit of the packet discard rate Dₙ is considered. A “discard traffic upper limit E_{R}” corresponding to the packet discard rate upper limit P_{R} is represented by P_{R}×B_{V}.

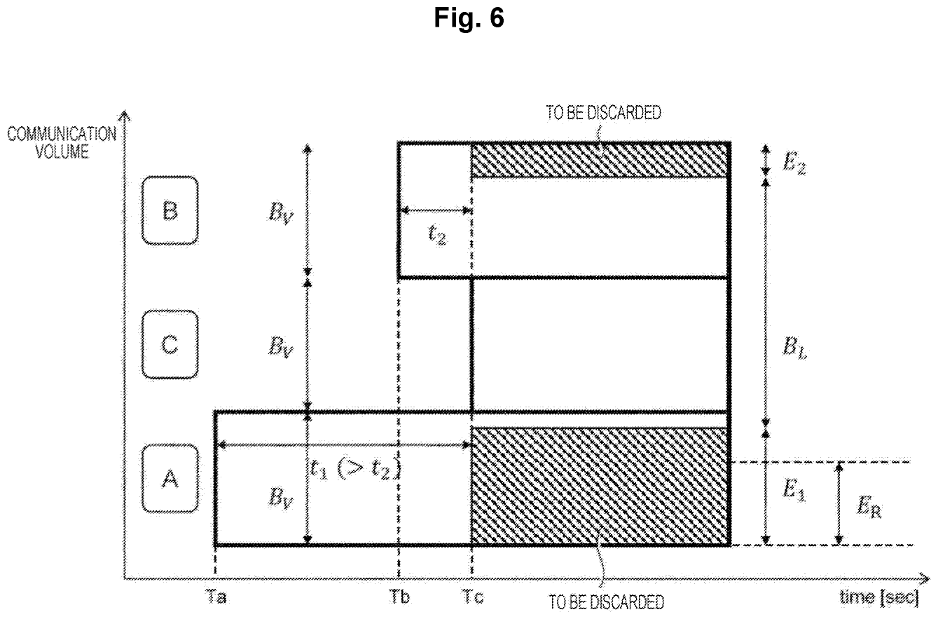

FIG. 6 illustrates one example of a result of the above-described first setting processing. Among all calls, the call duration t₁ of the user A is the longest, and the packet discard rate D₁ of the call of the user A is the highest. As a result of the first setting processing, the packet discard rate D₁ of the call of the user A exceeds the packet discard rate upper limit P_{R}. That is, the discard traffic amount E₁ allocated to the call of the user A exceeds the discard traffic upper limit E_{R}. Consequently, in order to reduce the discard traffic amount E₁ allocated to the call of the user A, the packet discard rate Dₙ of each of the calls is reset (adjusted).

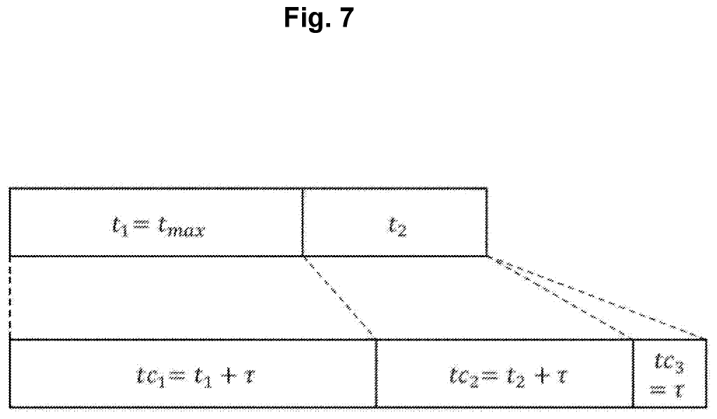

Specifically, as illustrated in FIG. 7, the traffic control device 100 calculates a corrected call duration tcₙ by adding a same correction amount τ to the call duration tₙ of each of the calls. The corrected call duration tcₙ is represented by a following expression (5).

[Math. 5]

tcₙ=tₙ+τ (5)

Then, the traffic control device 100 resets the packet discard rate Dₙ of each of the calls by using the corrected call duration tcₙ instead of the call duration tₙ. That is, the traffic control device 100 sets the packet discard rate Dₙ of each of the calls in a manner where the packet discard rate Dₙ is proportional to the corrected call duration tcₙ of each of the calls. The above-described processing of setting the packet discard rate Dₙ is hereinafter referred to as “second setting processing” for convenience. The packet discard rate Dₙ by the second setting processing is represented by a following expression (6).

$$\begin{matrix}[ Math . 6 ] & \\ {D}_{n} = \frac{{tc}_{n}}{{\sum }_{k = 1}^{z} {tc}_{k}} ( \frac{{E}_{d}}{{B}_{V}} ) = \frac{{t}_{n} + τ}{( {\sum }_{k = 1}^{z} {t}_{k} ) + z τ} ( \frac{{E}_{d}}{{B}_{V}} ) & ( 6 )\end{matrix}$$

A method of setting the correction amount τ is, for example, as follows. A longest call duration tₘₐₓ is a maximum value of the call durations to of all the calls. A maximum packet discard rate Dₘₐₓ is the packet discard rate Dₙ calculated by the above expression (6) with respect to the longest call duration tₘₐₓ. That is, the maximum packet discard rate Dₙ is a maximum value of the packet discard rate Dₙ set by the second setting processing. The correction amount τ is set so that the maximum packet discard rate Dₘₐₓ matches the packet discard rate upper limit P_{R}. In this case, a relationship represented by a following expression (7) is established.

$$\begin{matrix}[ Math . 7 ] & \\ {D}_{max} = \frac{{t}_{max} + τ}{( {\sum }_{k = 1}^{z} {t}_{k} ) + z τ} ( \frac{{E}_{d}}{{B}_{V}} ) = {P}_{R} & ( 7 )\end{matrix}$$

A following expression (8) is obtained from the expressions (7) and (3).

$$\begin{matrix}[ Math . 8 ] & \\ τ = \frac{{t}_{max} ( z - \frac{{B}_{L}}{{B}_{V}} ) - {P}_{R} ( {\sum }_{k = 1}^{z} {t}_{k} )}{z ( {P}_{R} - 1 ) + \frac{{B}_{L}}{{B}_{V}}} & ( 8 )\end{matrix}$$

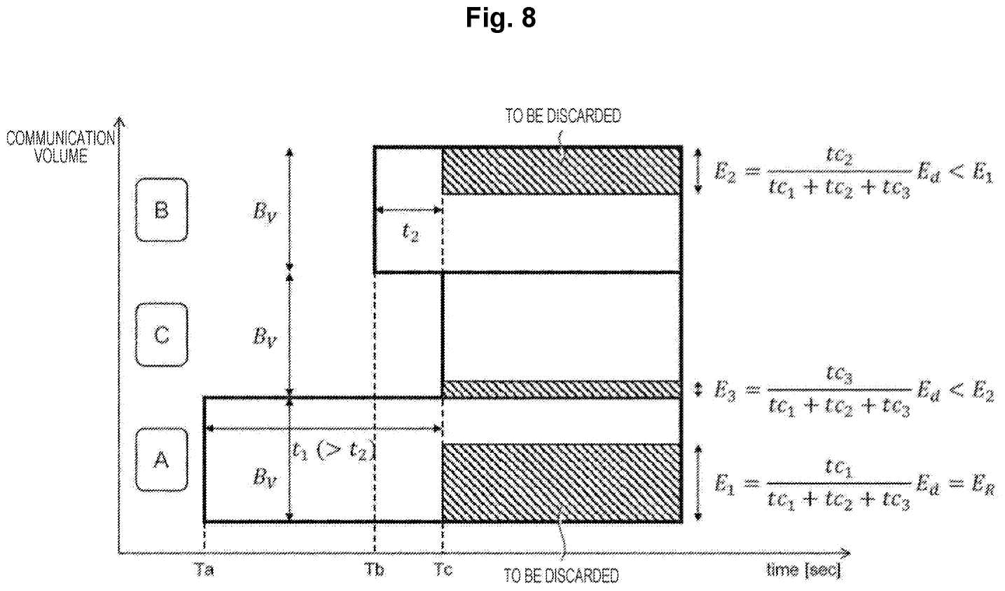

FIG. 8 illustrates a result of the second setting processing. There is no change in the tendency that “the longer the call duration tₙ is, the higher the packet discard rate Dₙ is and the larger the discard traffic amount Eₙ. is”. However, the packet discard rate D₁ (maximum packet discard rate Dₘₐₓ) of the call of the user A decreases to the packet discard rate upper limit P_{R}, and the discard traffic amount E₁ decreases to the discard traffic upper limit E_{R}. In addition, the packet discard rate D₃ of the new call is minimized. That is, it is possible to suppress the packet discard rate Dₙ of each of the calls to be equal to or lower than the packet discard rate upper limit P_{R} while minimizing influence on the new call.

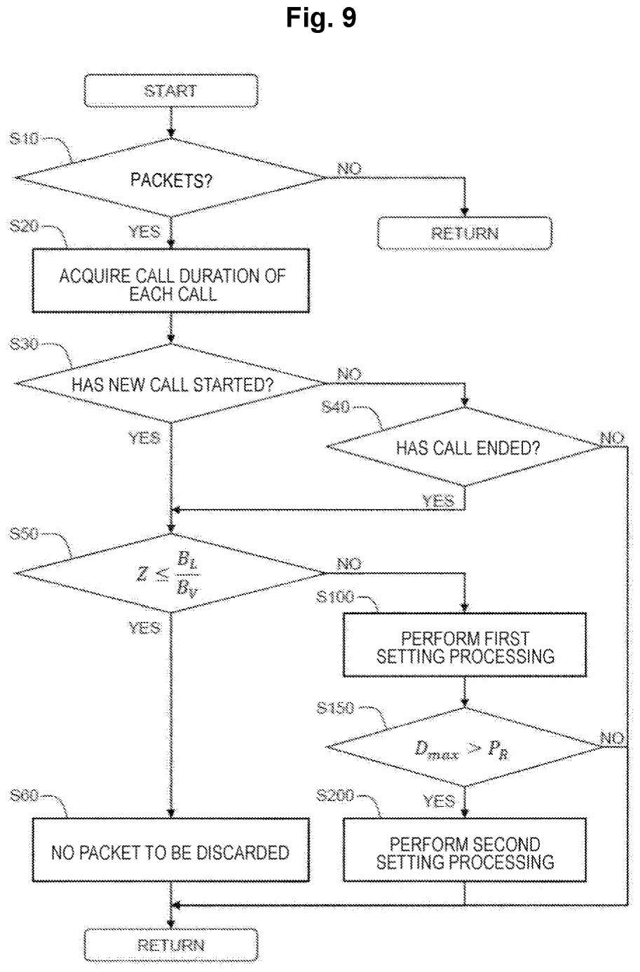

FIG. 9 is a flowchart illustrating the second example of the packet discard control processing. Steps S10 to S100 are the same as those in the above-described first example. In step S100, the traffic control device 100 executes the first setting processing.

In step S150, the traffic control device 100 determines whether or not the maximum packet discard rate Dₘₐₓ set by the first setting processing exceeds the packet discard rate upper limit P_{R}. If the maximum packet discard rate Dₘₐₓ set by the first setting processing is equal to or lower than the packet discard rate upper limit P_{R} (step S150; No), the result of the first setting processing is adopted. On the other hand, if the maximum packet discard rate Dₘₐₓ set by the first setting processing exceeds the packet discard rate upper limit P_{R} (step S150; Yes), the processing proceeds to step S200.

That is, in step S200, the traffic control device 100 executes the second setting processing of resetting the packet discard rate Dₙ of each of the calls. Specifically, the traffic control device 100 calculates the corrected call duration tcₙ by adding the correction amount τ to the call duration tₙ of each of the calls (see the expressions (5), (8)). Then, the traffic control device 100 resets the packet discard rate Dₙ of each of the calls in a manner where the packet discard rate Dₙ is proportional to the corrected call duration tcₙ of each of the calls. The above-described excellent effects can be obtained by the second setting processing.

### 4. Configuration Example of Traffic Control Device

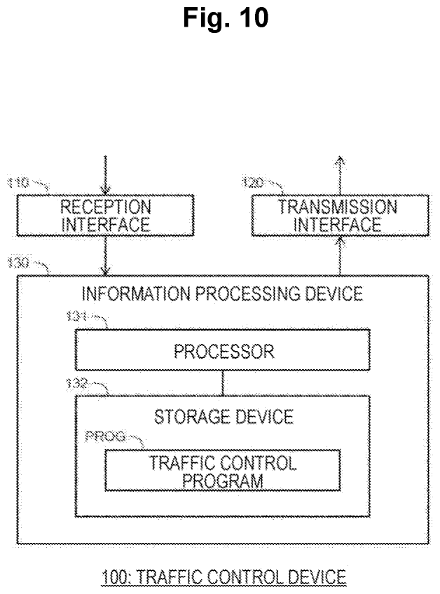

FIG. 10 is a block diagram illustrating a configuration example of the traffic control device 100 according to the present embodiment. The traffic control device 100 includes a reception interface 110, a transmission interface 120, and an information processing device 130. The reception interface 110 receives the packets from outside. The transmission interface 120 transmits the packets to outside.

The information processing device 130 performs various types of information processing. For example, the information processing device 130 includes a processor 131 and a storage device 132. The processor 131 performs various types of information processing. For example, the processor 131 includes a central processing unit (CPU). The storage device 132 stores various types of information necessary for processing by the processor 131. Examples of the storage device 132 include a volatile memory, a nonvolatile memory, an HDD (Hard Disk Drive), and an SSD (Solid State Drive).

A traffic control program PROG is a computer program executed by a computer. The function of the information processing device 130 is implemented by the processor 131 executing the traffic control program PROG. The traffic control program PROG is stored in the storage device 132. The traffic control program PROG may be recorded on a computer-readable recording medium. The traffic control program PROG may be provided via a network.

The information processing device 130 may be implemented with the use of hardware such as an ASIC (Application Specific Integrated Circuit), a PLD (Programmable Logic Device), or an FPGA (Field Programmable Gate Array).

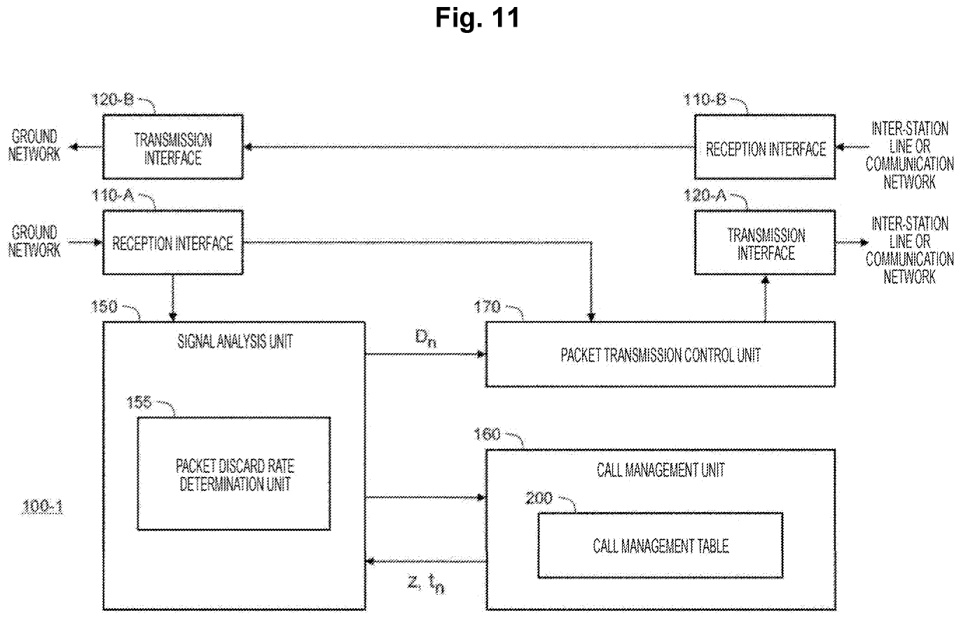

FIG. 11 is a block diagram illustrating a functional configuration example of the traffic control device 100-1 on a side of the base station 10. The traffic control device 100-1 includes a reception interface 110-A, a transmission interface 120-A, a reception interface 110-B, and a transmission interface 120-B. The reception interface 110-A receives packets from the ground network 2. The transmission interface 120-A transmits the packets to the inter-station line 3 or the communication network 4. The reception interface 110-B receives the packets from the inter-station line 3 or the communication network 4. The transmission interface 120-B transmits the packets to the ground network 2.

The traffic control device 100-1 further includes a signal analysis unit 150, a call management unit 160, and a packet transmission control unit 170. The signal analysis unit 150, the call management unit 160, and the packet transmission control unit 170 are implemented by the information processing device 130.

The signal analysis unit 150 receives the received packets from the reception interface 110-A. The signal analysis unit 150 analyzes each of the received packet and acquires information regarding the received packets. Specifically, the signal analysis unit 150 acquires a transmission source address, a transmission source port number, a destination address, and a destination port number of the received packet. In addition, the signal analysis unit 150 determines whether the received packet is for any of call start, call end, and others. The signal analysis unit 150 notifies the call management unit 160 of analysis result information indicating the transmission source address, the transmission source port number, the destination address, the destination port number, and classification (call start, call end, and others).

The call management unit 160 manages each of the calls handled by the traffic control device 100. Each of the calls is defined by a combination of the transmission source address, the transmission source port number, the destination address, and the destination port number. The call management unit 160 receives the analysis result information from the signal analysis unit 150 to generate and update a call management table 200 on the basis of the analysis result information.

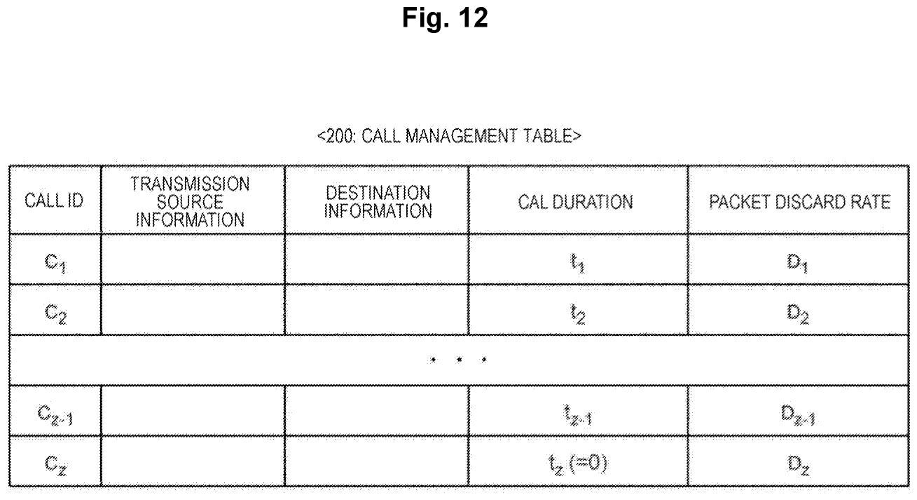

FIG. 12 is a conceptual diagram illustrating one example of the call management table 200. The call management table 200 has entries for each of the calls. Each of the entries includes a call ID (Cₙ), transmission information (the transmission source address, the transmission source port number), destination information (the destination address, the destination port number), and the call duration tₙ, and the packet discard rate Dₙ. A call start time may be used instead of the call duration tₙ or together with the call time tₙ. The call duration tₙ can be calculated from a current time and the call start time.

In a case where the classification of the received packet is the “call start”, the call management unit 160 creates the entries related to a new call. The transmission source information and the destination information on the new call are obtained from the analysis result information. The call management unit 160 assigns the call ID to the new call.

In a case where the classification of the received packet is the “call end”, the call management unit 160 deletes the entries related to the call.

Upon receiving the received packet, the signal analysis unit 150 inquires, of the call management unit 160, the number of simultaneous calls z and the call duration tₙ of each of the calls. The call management unit 160 refers to the call management table 200 to acquire the number of simultaneous calls z and the call duration tₙ of each of the calls. The call management unit 160 notifies the signal analysis unit 150 of the number of simultaneous calls z and the call duration tₙ of each of the calls.

A packet discard rate determination unit 155 of the signal analysis unit 150 determines the packet discard rate Dₙ of each of the calls on the basis of the number of simultaneous calls z and the call duration tₙ of each of the calls. Then, the signal analysis unit 150 notifies the packet discard rate Dₙ of each of the calls to the packet transmission control unit 170.

The packet transmission control unit 170 receives the received packet from the reception interface 110-A. The packet transmission control unit 170 appropriately performs the packet discard in accordance with the packet discard rate Dₙ notified from the signal analysis unit 150. Then, the packet transmission control unit 170 transmits the packets that have not been discarded via the transmission interface 120-A.

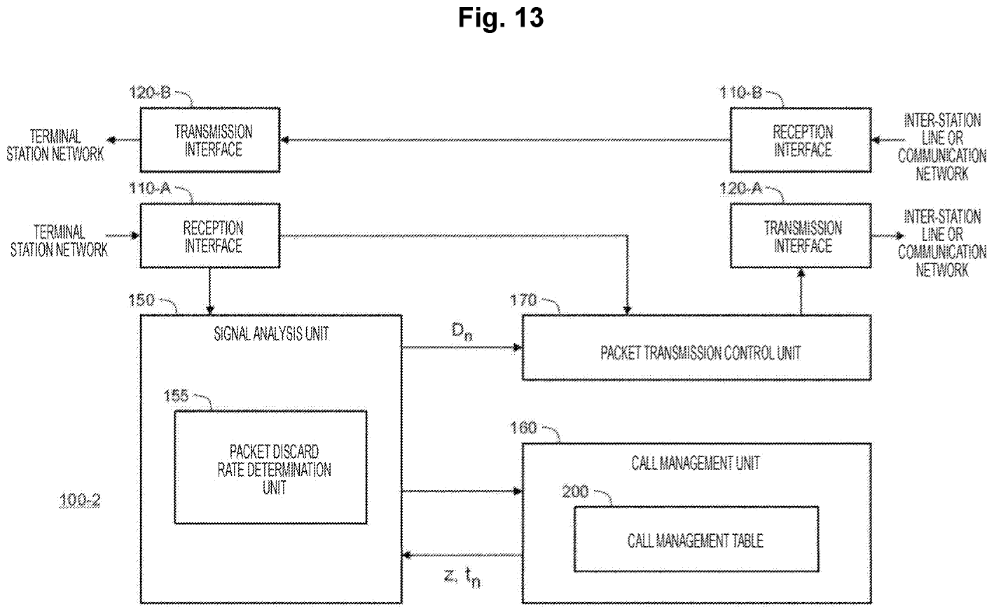

FIG. 13 is a block diagram illustrating a functional configuration example of the traffic control device 100-2 on a side of the terminal station 20. A configuration of the traffic control device 100-2 is similar to the configuration of the traffic control devices 100-1 illustrated in FIG. 11. However, the reception interface 110-A receives packets from the terminal station network 5, and the transmission interface 120-B transmits packets to the terminal station network 5. Functions of the signal analysis unit 150, the call management unit 160, and the packet transmission control unit 170 are similar to those of the traffic control device 100-1 illustrated in FIG. 11.

### REFERENCE SIGNS LIST

1 IP phone system
2 Ground network
3 Inter-station line
4 Communication network
5 Terminal station network
10 Base station
20 Terminal station
100 Traffic control device
110 Reception interface
120 Transmission interface
130 Information processing device
131 Processor
132 Storage device
150 Signal analysis unit
155 Packet discard rate determination unit
160 Call management unit
170 Packet transmission control unit
200 Call management table
PROG Traffic control program

1. An Internet Protocol (IP) phone system comprising
a traffic control device connected to a line, wherein
the traffic control device executes:
processing of acquiring a call duration of each of calls on one line shared by a plurality of IP phones; and
first setting processing of setting a packet discard rate of each of the calls in a manner where the packet discard rate is proportional to the call duration until start of a new call so that total call traffic falls within a line capacity of the one line when the total call traffic exceeds the line capacity with the start of the new call.

2. The IP phone system according to claim 1, wherein
the traffic control device further executes
second setting processing of resetting the packet discard rate of each of the calls when a maximum value of the packet discard rate set by the first setting processing exceeds a predetermined upper limit, and
the second setting processing includes:
processing of calculating a corrected call duration by adding a correction amount to the call duration of each of the calls; and
processing of resetting the packet discard rate of each of the calls in a manner where the packet discard rate is proportional to the corrected call duration so that the total call traffic falls within the line capacity.

3. The IP phone system according to claim 2, wherein
the traffic control device sets the correction amount so that a maximum value of the packet discard rate set by the second setting processing becomes the predetermined upper limit.

4. A traffic control method in an Internet Protocol (IP) phone system, the traffic control method comprising:
processing of acquiring a call duration of each of calls on one line shared by a plurality of IP phones; and
first setting processing of setting a packet discard rate of each of the calls in a manner where the packet discard rate is proportional to the call duration until start of a new call so that total call traffic falls within a line capacity of the one line when the total call traffic exceeds the line capacity with the start of the new call.

5. The traffic control method according to claim 4, further comprising
second setting processing of resetting the packet discard rate of each of the calls when a maximum value of the packet discard rate set by the first setting processing exceeds a predetermined upper limit, wherein
the second setting processing includes:
processing of calculating a corrected call duration by adding a correction amount to the call duration of each of the calls; and
processing of resetting the packet discard rate of each of the calls in a manner where the packet discard rate is proportional to the corrected call duration so that the total call traffic falls within the line capacity.

6. The traffic control method according to claim 5, wherein
the correction amount is set so that a maximum value of the packet discard rate set by the second setting processing becomes the predetermined upper limit.

7. A traffic control program that is executed by a computer and causes the computer to execute the traffic control method according to claim 4.

8. A traffic control device in an Internet Protocol (IP) phone system, the traffic control device comprising
an information processing device, wherein
the information processing device executes:
processing of acquiring a call duration of each of calls on one line shared by a plurality of IP phones; and
first setting processing of setting a packet discard rate of each of the calls in a manner where the packet discard rate is proportional to the call duration until start of a new call so that total call traffic falls within a line capacity of the one line when the total call traffic exceeds the line capacity with the start of the new call.
